(19) United States
(12) Patent Application Publication
(10) Pub. No.: US 2024/0012640 A1
(43) Pub. Date: Jan. 11, 2024

(54) PROCESSOR CIRCUIT, METHOD OF MANAGING VERSION, AND COMPUTER-READABLE RECORDING MEDIUM STORING VERSION MANAGING PROGRAM

(71) Applicant: Fujitsu Limited, Kawasaki-shi (JP)

(72) Inventor: Masao Yoshikawa, Kawasaki (JP)

(73) Assignee: Fujitsu Limited, Kawasaki-shi (JP)

(21) Appl. No.: 18/188,792

(22) Filed: Mar. 23, 2023

(30) Foreign Application Priority Data
Jul. 6, 2022 (JP) 2022-108795

(51) Int. Cl. G06F 8/71; G06F 8/65

(52) U.S. Cl. CPC G06F 8/71; G06F 8/65

(57) ABSTRACT

A processor circuit for managing a version of software to be started includes a nonvolatile memory that holds a first counter value of a first counter and a second counter value of a second counter. The processor circuit also includes a start control circuit that updates the first counter value and maintains the second counter value in a case where the version of the software is incremented, that maintains the first counter value and updates the second counter value in a case where the version of the software is decremented, and starts the software in a case where the version of the software to be started is equal to a check value for a version check indicated by a difference between the first counter value and the second counter value.

### CROSS-REFERENCE TO RELATED APPLICATION

This application is based upon and claims the benefit of priority of the prior Japanese Patent Application No. 2022-108795, filed on Jul. 6, 2022, the entire contents of which are incorporated herein by reference.

### FIELD

The embodiments discussed herein are related to a processor circuit, a method of managing a version, and a computer-readable recording medium storing a version managing program.

### BACKGROUND

A technique is known in which, to protect firmware from rollback attacks, the version of the firmware is stored in a one time programmable (OTP) memory so as to allow update of the version only in an incrementing direction. For example, the version of the firmware is held in the OTP memory as a major version and held in a nonvolatile memory as a minor version.

Japanese Laid-open Patent Publication No. 2021-179982 is disclosed as related art.

### SUMMARY

According to an aspect of the embodiments, a processor circuit for managing a version of software to be started including a nonvolatile memory that holds a first counter value of a first counter and a second counter value of a second counter, and a start control circuit that updates the first counter value and maintains the second counter value in a case where the version of the software is incremented, that maintains the first counter value and updates the second counter value in a case where the version of the software is decremented, and starts the software in a case where the version of the software to be started is equal to a check value for a version check indicated by a difference between the first counter value and the second counter value.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a motherboard over which a processor circuit according to one embodiment is mounted;

FIGS. 2A to 2C are explanatory diagrams illustrating an example in which update of a version of firmware is managed by using counters illustrated in FIG. 1;

FIG. 3 is a flowchart illustrating an example of a firmware update operation performed by the processor circuit of FIG. 1;

FIG. 4 is a block diagram illustrating an example of a motherboard over which a processor circuit according to an other embodiment is mounted;

FIG. 5 is an explanatory diagram illustrating an example in which update of the version of the firmware is managed by using counters illustrated in FIG. 4;

FIGS. 6A and 6B is a configuration diagram illustrating other examples of the counters according to the above-described embodiment; and

FIG. 7 is a block diagram illustrating an example of a motherboard over which a processor circuit according to yet an other embodiment is mounted.

### DESCRIPTION OF EMBODIMENTS

In a case where the firmware is protected from rollback attacks by managing the version of the firmware with the OTP memory, the firmware is not easily returned to an older version. Accordingly, for example, when a problem occurs in the firmware, testing while switching the version is not easily performed. This reduces efficiency of debugging the firmware.

For example, when a plurality of counters that manage the version in the OTP memory are provided so as to switch the counters used for managing the version, the firmware may be easily returned to an older version. In this case, however, counters that handle the number of times of switching equal to or greater than the assumed number of times of switching are desired to be provided. Thus, the OTP memory space is increased.

In one aspect, the present disclosure is aimed at suppressing a space of a memory in which a counter that manages a version of software is provided. Hereinafter, embodiments will be described with reference to the drawings.

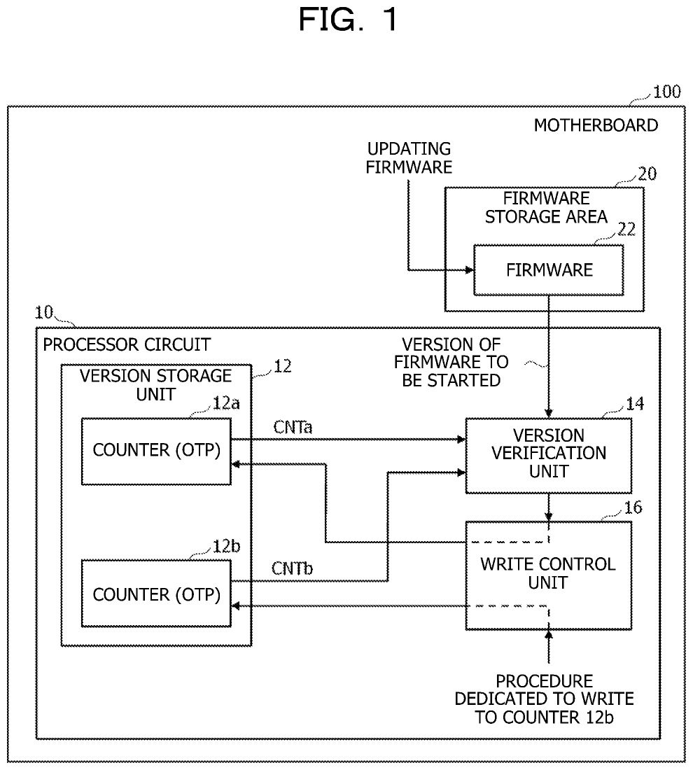

FIG. 1 illustrates an example of a motherboard over which a processor circuit according to one embodiment is mounted. A processor circuit 10 illustrated in FIG. 1 is, for example, a central processing unit (CPU) or the like. The processor circuit 10 is mounted over a motherboard 100 together with a firmware storage area 20 in which firmware 22 is stored. The firmware 22 is an example of software.

The processor circuit 10 in the form of a chip and the firmware storage area 20 in the form of a chip may be separately mounted over the motherboard 100. Alternatively, the processor circuit 10 and the firmware storage area 20 in a form in which both the components are integrated into a single chip may be mounted over the motherboard 100. For example, the motherboard 100 is mounted in an information processing apparatus such as a server, a supercomputer, or a personal computer (PC) and realizes the functions of the information processing apparatus.

The firmware 22 held in the firmware storage area 20 is executed by a CPU core or the like mounted in the processor circuit 10. Although it is not particularly limited, for example, the firmware storage area 20 is allocated in an electrically rewritable memory such as a flash memory and allows overwriting of updating firmware. Alternatively, the firmware storage area 20 may be allocated in a memory in which either or both of an operating system (OS) and an application program executed by the processor circuit 10 are stored.

The processor circuit 10 includes a version storage unit 12, a version verification unit 14, and a write control unit 16. The version verification unit 14 and the write control unit 16 are examples of a start control unit. The version storage unit 12 includes counters 12a and 12b used to manage the version of the firmware 22. For example, the version storage unit 12 is provided in an on-chip one-time programmable (OTP) memory. The version storage unit 12 is an example of a nonvolatile memory. The counter 12a is an example of a first counter and the counter 12b is an example of a second counter.

For example, since an OTP memory stores bit information in each of a plurality of E-fuses, information written in each bit (E-fuse) of the OTP memory is unable to be rewritten. For example, the OTP memory allows writing of a value of each of a plurality of bits thereto only once. With the OTP memory according to the embodiment, the value of a bit to which “1” is written is unable to be returned to “0”. Accordingly, for example, in the counter 12a, the number of bits holding “1” increases every time the version increments.

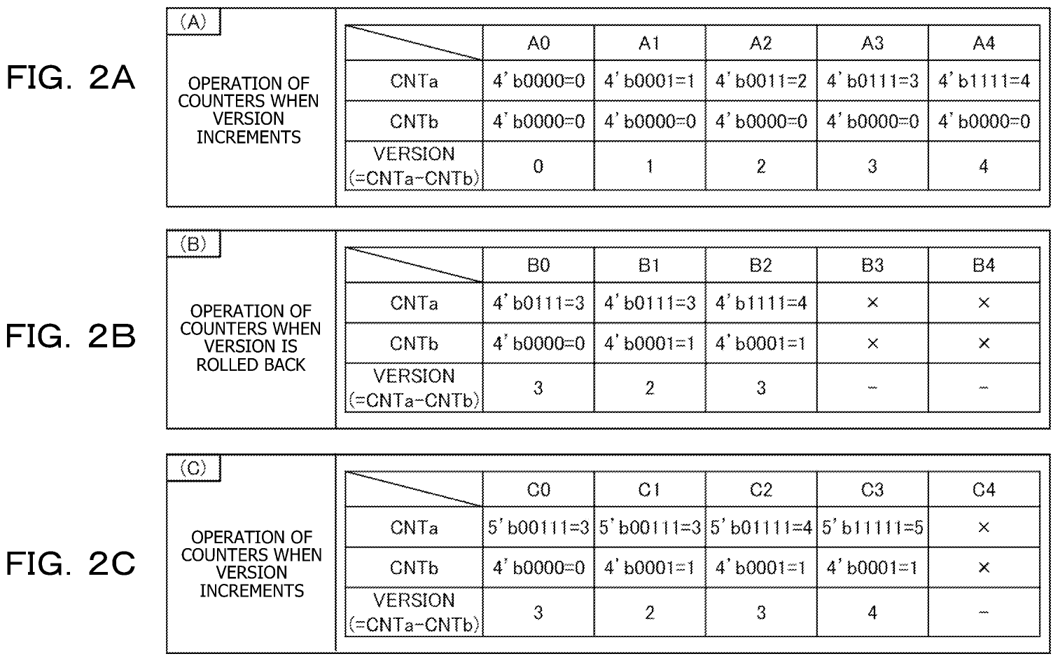

A counter value CNTa of the counter 12a and a counter value CNTb of the counter 12b are indicated by the number of bits set to “1”. A check value for a version check is indicated by a difference (CNTa−CNTb) between the counter values CNTa and CNTb. The check value indicates a version of the firmware 22 that may be started. An example of use of the counters 12a and 12b is illustrated in FIGS. 2A to 2C. The counter value CNTa is an example of a first counter value, and the counter value CNTb is an example of a second counter value.

At the time of the start of the firmware 22 held in the firmware storage area 20, the version verification unit 14 compares the version of the firmware 22 to be started to the check value of the version held in the version storage unit 12. Based on the comparison between the version of the firmware 22 and the difference between the counter values CNTa and CNTb, the version verification unit 14 determines which of a normal start process, an upgrading process, or an error process (stop of the start) of the firmware is to be executed.

In a case where the version of the firmware 22 to be started is greater than the difference between the counter values CNTa and CNTb, the version verification unit 14 issues an instruction to increment the counter value CNTa of the counter 12a to the write control unit 16. In a case where the version of the firmware 22 to be started is equal to the difference between the counter values CNTa and CNTb, the version verification unit 14 causes the processor circuit 10 to perform the start process of the firmware 22. In a case where the version of the firmware 22 to be started is smaller than the difference between the counter values CNTa and CNTb, the version verification unit 14 notifies an error processing unit or the like of the processor circuit 10 of the occurrence of an error.

The write control unit 16 controls write operations to the counters 12a and 12b. Based on an instruction from the version verification unit 14, the write control unit 16 performs a write operation for updating the counter value CNTa of the counter 12a. In a case where a rollback process that decrements the version of the firmware 22 is performed, the write control unit 16 performs a write operation to the counter 12b based on a procedure dedicated to write to the counter 12b to update the counter value CNTa. For example, the procedure dedicated to the write to the counter 12b is password authentication, public-key authentication, or the like. The procedure dedicated to the write to the counter 12b is not limited to the password authentication, public-key authentication, or the like and may be biometric authentication or the like. When the procedure dedicated to the write to the counter 12b is employed, security against the rollback of the firmware 22 may be ensured.

For example, the operations of the version verification unit 14 and the write control unit 16 are realized by a version managing program executed by the processor circuit 10. When the version managing program is executed, a method of managing a version is realized. The error processing unit may be realized by an error processing program executed by the processor circuit 10. One or more of the version verification unit 14, the write control unit 16, and the error processing unit may be implemented by hardware.

FIGS. 2A to 2C illustrate an example in which update of the version of the firmware is managed by using the counters 12a and 12b illustrated in FIG. 1. Operations illustrated in FIGS. 2A to 2C represent an example of the method of managing a version performed by the version verification unit 14 and the write control unit 16. Also, the operations illustrated in FIGS. 2A to 2C represent an example of operations performed by the version managing program executed by the processor circuit 10.

The counter values CNTa and CNTb of the counters 12a and 12b increment by setting a bit value of “1” one by one from the least significant bit toward a higher bit. The bit value is unable to be rewritten from “1” to “0”. The check value for the version of the firmware set in the version storage unit 12 is indicated by the difference between the counter values CNTa and CNTb (CNTa−CNTb). At the top of the counter values CNTa and CNTb, “4′b” or “5′h” is indicated. Four bits of binary numbers and five bits of binary numbers are respectively indicated by “4′b” and “5′b”.

FIG. 2A illustrates an example of operations of the counters 12a and 12b in a case where the version (check value) of the firmware increments. Referring to FIG. 2A, the version of the firmware 22 is sequentially updated from “0” to “4” from a state A0 to a state A4. Since the counter value CNTb of the counter 12b is maintained at “0”, the counter value CNTa indicates the check value. In a case where the counter value CNTa matches the firmware 22 to be started, the firmware 22 is started.

FIG. 2B illustrates an example of operations of the counters 12a and 12b in a case where a problem occurs after the version of the firmware 22 has been incremented and the version (check value) is rolled back by one. When the version (check value) is returned, before the firmware 22 is started, the counter value CNTb of the counter 12b is incremented by a value corresponding to the difference between the current version and the version after the return.

In an initial state B0 of FIG. 2B, since the counter value CNTa is “4′b0111=3”, the version of the firmware 22 that may be started is “3”. In this example, to return the version by one, the counter value CNTb increments by “1” from “4′b0000” of a state B0 to “4′b0001” of a state B1. When the counter value CNTb increments by “1”, the version of the firmware 22 that may be started is “2”.

As described above, to ensure the security, the counter value CNTb is updated through a transition to a state dedicated to rollback by using a password authentication method, a public-key authentication method, or the like. In a case where a dedicated state aimed at testing for which the security is ensured or debugging of a device for which the security is ensured is prepared, the counter value CNTb may be updated in accordance with a procedure for testing or debugging.

After that, in a case of starting the firmware 22 of the version=“3”, the counter value CNTa increments by “1” from “4′b0111” of the state B1 so as to be updated to “4′b1111” of the state B2. As a result, the check value held in the version storage unit 12 returns to “3”, and the firmware 22 of the version=“3” may be started.

FIG. 2C illustrates an example of operations of the counters 12a and 12b in a case where the numbers of bits of the counters 12a and 12b are greater than those of FIG. 2B by one. States C0 to C2 of FIG. 2C are similar to the states B0 to B2 of FIG. 2B except for that the numbers of bits of the counters 12a and 12b vary. When the numbers of bits of the counters 12a and 12b increase by one bit, even in a case where the version is returned to the previous version by one, the version of the firmware 22 that may be started may be updated to “4” thereafter.

In a case where the version (check value) is returned, the maximum value of the check value that may be indicated by the counter values CNTa and CNTb reduces. For example, with the four-bit counter 12a illustrated in FIG. 2B, the version is not able to be set to “4”. With the five-bit counter 12a illustrated in FIG. 2C, the version is not able to be set to “5”. Accordingly, the numbers of bits of the counters 12a and 12b are designed in accordance with the maximum version number and the maximum number of times of rollback in consideration of an assumed operation status of the firmware. Although the numbers of bits of the counters 12a and 12b are set to four bits or five bits in FIGS. 2A to 2C, the numbers of bits of the counters 12a and 12b may be set to arbitrary values in accordance with the maximum number of times of update of the version of the firmware 22.

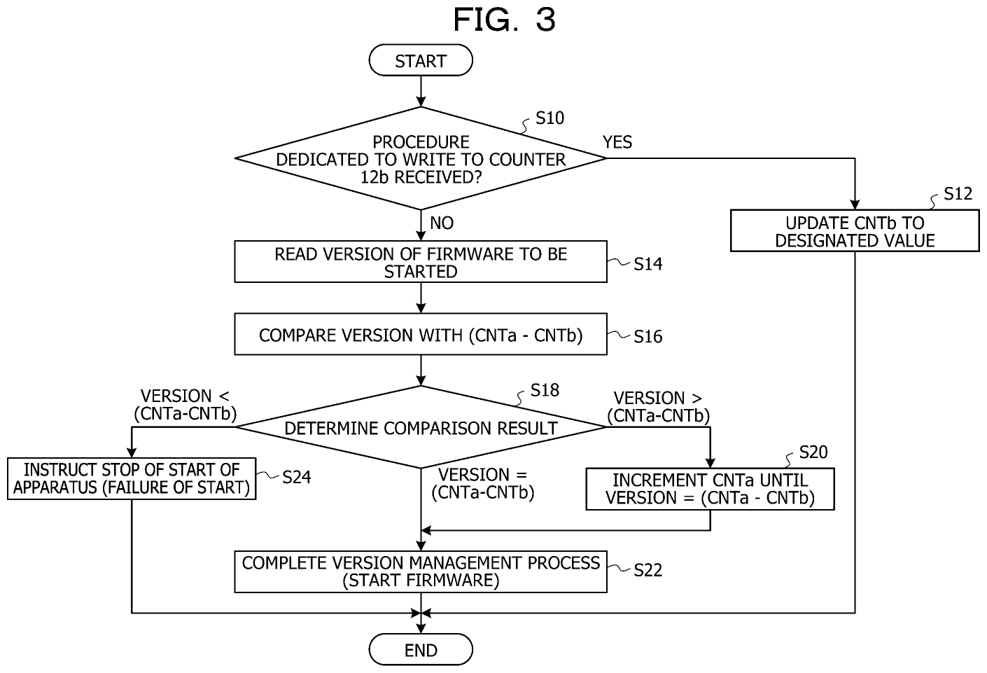

FIG. 3 illustrates an example of a flow of a firmware update operation performed by the processor circuit 10 of FIG. 1. Based on a fact that an apparatus in which the motherboard 100 is mounted has been started, the processor circuit 10 starts a firmware start process illustrated in FIG. 3.

First, in step S10, the write control unit 16 determines whether the procedure dedicated to write to the counter 12b is received. In a case where the dedicated procedure is received, the write control unit 16 causes processing to move to step S12. In a case where the dedicated procedure is not received, the write control unit 16 causes the processing to move to step S14 to perform the normal firmware start process.

In step S12, the write control unit 16 performs an authentication process or the like through the dedicated procedure, updates the counter value CNTb of the counter 12b to a designated value based on success of the authentication process, and ends the processing illustrated in FIG. 3. After the counter 12b has been updated, the apparatus in which the motherboard 100 is mounted is restarted. Thus, the processing illustrated in FIG. 3 is performed again after the counter 12b has been updated.

In step S14, the version verification unit 14 reads the version of the firmware 22 to be started from the firmware storage area 20. Next, in step S16, the version verification unit 14 compares the read version to the difference between the counter values CNTa and CNTb (CNTa−CNTb; check value) read from the counters 12a and 12b.

Next, in step S18, in a case where the read version is greater than the difference (CNTa−CNTb), the version verification unit 14 causes the processing to move to step S20 to match the check value held in the version storage unit 12 and the version of the firmware 22 to be started with each other. In a case where the read version is equal to the difference (CNTa−CNTb), the firmware 22 read from the firmware storage area 20 may be started. Thus, the version verification unit 14 causes the processing to move to step S22. In a case where the read version is smaller than the difference (CNTa−CNTb), the version verification unit 14 detects an error in the firmware 22 start process and causes the processing to move to step S24 to stop the start of the firmware 22.

In step S20, the version verification unit 14 notifies the write control unit 16 of the difference between the version of the firmware 22 to be started and the check value (CNTa−CNTb). Based on the received difference, the write control unit 16 increments the counter value CNTa of the counter 12a until the check value (CNTa−CNTb) becomes equal to the version of the firmware 22. After step S20, the processing moves to step S22. In step S22, the version verification unit 14 completes a version management process, instructs the processor circuit 10 to start the firmware 22, and ends the processing illustrated in FIG. 3. After the firmware 22 has been started, for example, the OS is started.

In step S24, the version verification unit 14 causes the processor circuit 10 to stop the start of the firmware 22. The version verification unit 14 outputs the occurrence of the error and an instruction to stop the start of the apparatus in which the motherboard 100 is mounted to the error processing unit or the like of the processor circuit 10, and the processing illustrated in FIG. 3 ends (a failure of the start). This may suppress the start of the firmware 22 of a wrong version.

As described above, according to the present embodiment, the write control unit 16 updates one of the two counters CNTa and CNTb provided in the version storage unit 12 which is a nonvolatile memory when the version is incremented and updates the other when the version is decremented. Accordingly, the increment or decrement of the version may be performed a plurality of times with the two counters CNTa and CNTb. As a result, the space of the memory for managing the version of software such as firmware may be suppressed.

The version may be incremented by incrementing the counter value CNTa, and the version may be decremented by incrementing the counter value CNTb. Thus, for example, the upgrading and degrading may be easily managed by using the check value that is the difference between the counter values CNTa and CNTb of the counters 12a and 12b provided in the OTP memory. For example, when the version of the firmware 22 to be started is greater than the check value, the upgrading may be easily performed by updating the counter value CNTa until the check value and the version of the firmware 22 to be started are equal to each other.

In the case where the version of the firmware 22 to be started is smaller than the difference (CNTa−CNTb), the version verification unit 14 detects an error in the firmware 22 start process and stops the start of the firmware 22. This may suppress the start of the firmware 22 of a wrong version.

The counter value CNTb used when the version is rolled back is updated based on the procedure dedicated to the write to the counter 12b such as the authentication process. Thus, both ensuring of the security and the operability in version management of firmware may be achieved. Here, the operability includes, for example, when a problem with the firmware occurs, an ability to perform testing by quickly rolling back the version, an ability to suppress reduction in efficiency of debugging the firmware by the testing with the quick rollback, and so forth. In contrast, in a case where replacement of the apparatus occurs to perform the rollback of the firmware, it is difficult to perform the rollback quickly.

An apparatus such as a server in which the motherboard 100 is mounted is often coupled to a network and may be subjected to cyber attacks via the network. Even in such a case, unauthorized rollback or the like of the firmware 22 may be suppressed, and accordingly, the possibility of the occurrences of problems such as infection of the apparatus with a computer virus may be reduced. As a result, reduction of the reliability of the apparatus such as the server in which the motherboard 100 is mounted may be suppressed.

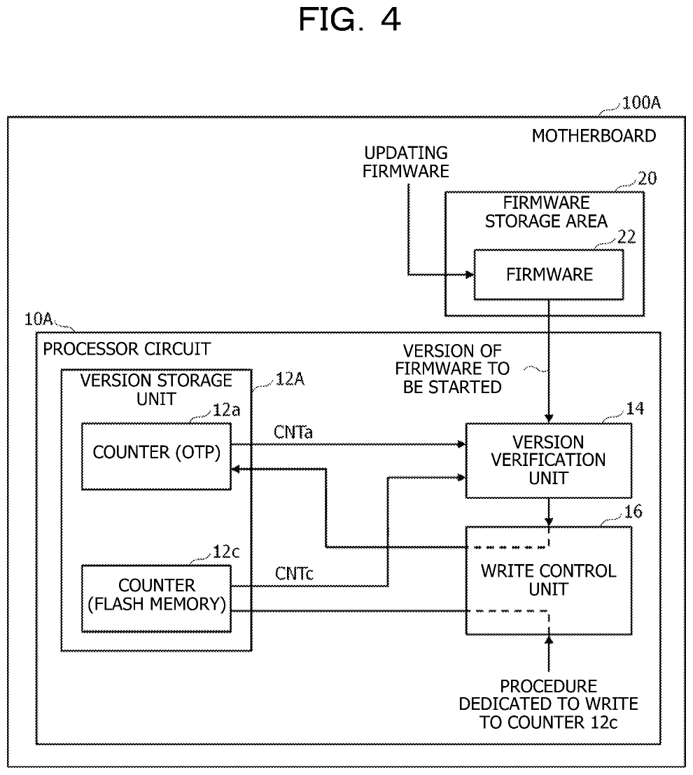

FIG. 4 illustrates an example of a motherboard over which a processor circuit according to an other embodiment is mounted. Elements similar to those of FIG. 1 are denoted by the same reference numerals, and detailed description is omitted for such elements. A processor circuit 10A illustrated in FIG. 4 is, for example, a CPU or the like and mounted over a motherboard 100A together with the firmware storage area 20 in which the firmware 22 is stored.

The motherboard 100A has a similar configuration as that of the motherboard 100 of FIG. 1 except for that the processor circuit 10A is mounted instead of the processor circuit 10 of FIG. 1. The processor circuit 10A has a similar configuration as that of the processor circuit 10 of FIG. 1 except for that the processor circuit 10A includes a version storage unit 12A instead of the version storage unit 12 of FIG. 1.

The version storage unit 12A is similar to the version storage unit 12 of FIG. 1 except for that a counter 12c is mounted instead of the counter 12b of in FIG. 1. The counter 12c generates a counter value CNTc. The version storage unit 12A is an example of the nonvolatile memory. The counter 12a that holds the counter value CNTa is an example of a first nonvolatile memory. The counter 12c that holds the counter value CNTc is an example of a second nonvolatile memory.

For example, the counter 12c is provided by using a nonvolatile memory such as a flash memory that allows rewriting of the value of each of a plurality of bits a plurality of times. Thus, the counter 12c is operable as a normal binary counter, and the counter value CNTc is indicated by a binary number. Accordingly, the number of bits to be used may be saved compared to the counter 12b of FIG. 1 in which the counter value CNTb is indicated by the number of bits set to “1”. For example, a memory resource used for the counter 12c may be further reduced compared to that of FIG. 1. For example, in a case where “0” to “4” are counted, the counter 12b of FIG. 1 uses four bits whereas the counter 12c uses three bits. In a case where the counter 12c has four bits, “0” to “15” may be counted.

In a case where a nonvolatile memory such as a flash memory is used for the counter 12c, the value of the bit to which “1” has been written may be returned to “0”. However, write to the counter 12c is performed by the write control unit 16 through the procedure dedicated to the write to the counter 12c such as the password authentication or the public-key authentication. Thus, writing an unauthorized value to the counter 12c may be suppressed, and unauthorized rollback of the firmware may be suppressed. The procedure dedicated to the write to the counter 12c is not limited to the password authentication, public-key authentication, or the like.

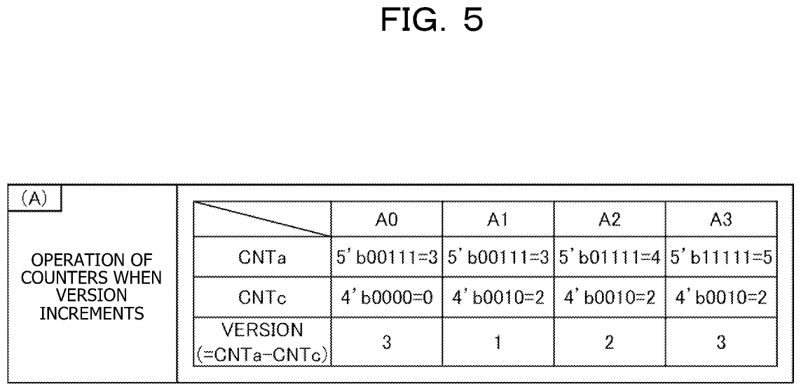

FIG. 5 illustrates an example in which update of the version of the firmware is managed by using the counters 12a and 12c illustrated in FIG. 4. Detailed description is omitted for the same operation as that of FIGS. 2A to 2C. FIG. 5 illustrates an example of operations of the counters 12a and 12c in a case where a problem occurs after the firmware 22 has been upgraded and the version is rolled back by two. As is the case with FIG. 2B, to return the version, before the firmware 22 is started, the counter value CNTc of the counter 12c is incremented by a value corresponding to the difference between the current version and the return target version.

In this example, to return the version by two, the counter value CNTc increments by “2” from “4′b0000” of a state A0 to “4′b0010” of a state A1. Accordingly, the difference between the counter values CNTa and CNTc is “1”, and the firmware 22 of version=“1” may be started. In the initial state A0, since the counter value CNTa is “5′b00111=3”, the version of the firmware 22 that may be started is “3”.

A flow of the firmware update operation performed by the processor circuit 10A of FIG. 4 is the same as that of FIG. 3. Accordingly, the counter value CNTa of the counter 12a is updated in a case where the version of the firmware 22 is greater than the check value that is the difference between the counter values CNTa and CNTc at a normal start of the firmware 22. Since the OTP memory is used for the counter 12a, the counter 12a is updated only in an incrementing direction. Accordingly, for example, even in a case where the counter 12a is maliciously updated, the counter 12a is only updated to a value greater than the current version, and the apparatus is not necessarily started after the update. Since the counter value CNTc may be updated only in step S12 of FIG. 3, the update of the counter value CNTc of the counter 12c is prohibited under any condition at the normal start of the firmware 22. Accordingly, the security of the apparatus related to the version of the firmware may be ensured.

After that, in a case where the firmware 22 of version=“2” is started again, the counter value CNTa is updated from “5′b00111” of the state A1 to “5′b01111” of the state A2. Accordingly, the version held in the version storage unit 12 is set to “2”. In a case where the firmware 22 of version=“3” is started again, the counter value CNTa is updated from “5′b01111” of the state A2 to “5′b11111” of the state A3. Accordingly, the version held in the version storage unit 12 is set to “3”. Also in FIG. 5, the numbers of bits of the counters 12a and 12c are designed in accordance with the maximum version and the maximum number of times of rollback in consideration of an assumed operation status of the firmware.

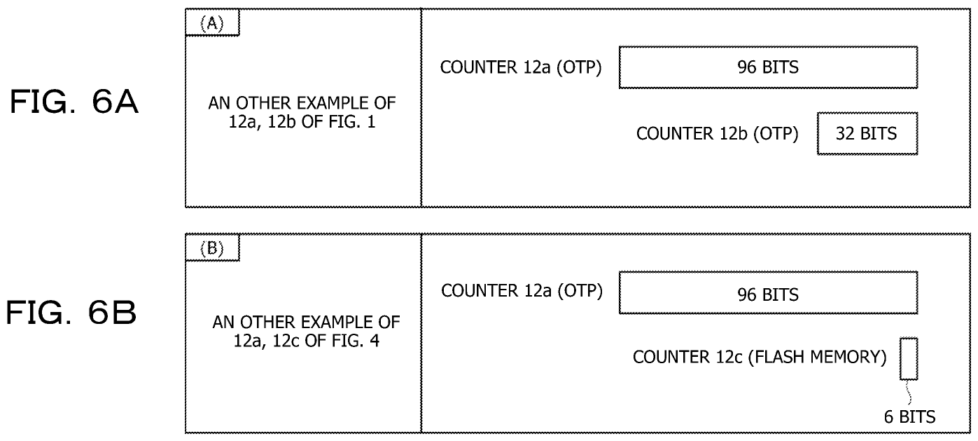

FIGS. 6A and 6B illustrate other examples of the counters according to the above-described embodiment. Referring to FIG. 6A, the number of bits of the counter 12a (OTP) of FIG. 1 is set to be 96 bits, and the number of bits of the counter 12b (OTP) of FIG. 1 is set to be 32 bits. As a result, versions able to be rolled back may be set to “32” at the maximum. Even in a case where the maximum number of times of rollbacks have been performed, versions up to “64” may be handled.

Referring to FIG. 6B, the number of bits of the counter 12a (OTP) of FIG. 4 is set to be 96 bits, and the number of bits of the counter 12c (flash memory) of FIG. 4 is set to be 6 bits. Since the counter value CNTc is represented by a binary number, the counter 12c may be set to “0” to “63” equal to or greater than the rollbacks that may be realized by the counter 12b. Accordingly, the memory resource may be reduced.

As described above, according to the present embodiment, effects similar to those of the above-described embodiment may be obtained. For example, the version may be incremented or decremented a plurality of times with the two counters CNTa and CNTc, and accordingly, the space of the memory for managing the version of software such as firmware may be suppressed. Upgrading and downgrading may be easily managed by using the check value that is the difference between the counter values CNTa and CNTc of the counters 12a and 12c.

According to the present embodiment, the counter 12c is provided by using a nonvolatile memory such as a flash memory that is operable as a normal binary counter. Thus, compared to the counter 12b of FIG. 1, the number of bits to be used may be saved. As a result, the memory resource used for the counter 12c may be further reduced compared to that of FIG. 1.

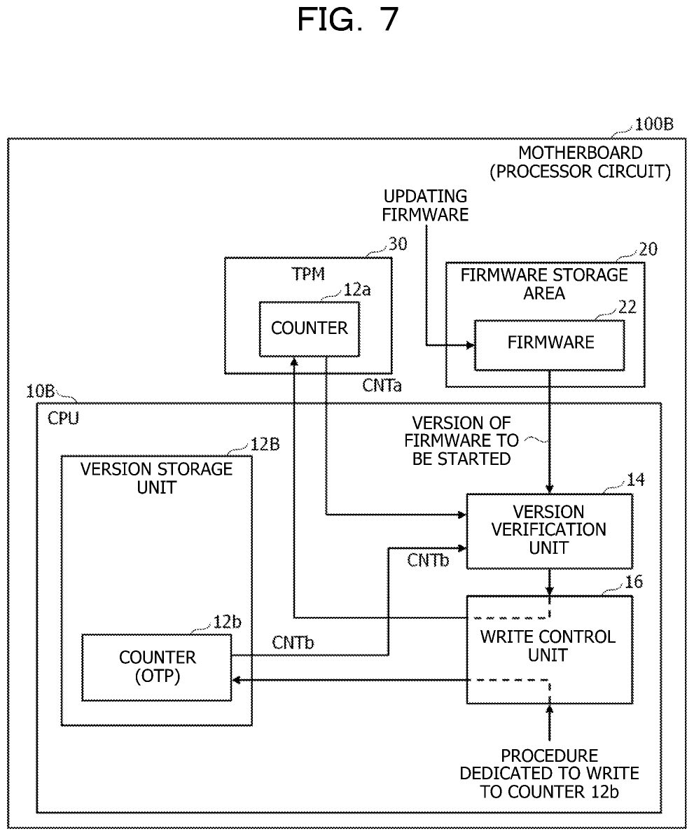

FIG. 7 illustrates an example of a motherboard over which a processor circuit according to a yet an other embodiment is mounted. Elements similar to those of FIG. 1 are denoted by the same reference numerals, and detailed description is omitted for such elements. A motherboard 100B illustrated in FIG. 7 includes a CPU 10B, the firmware storage area 20, and a trusted platform module (TPM) 30 including various types of functions related to the security. The motherboard 100B is similar to the motherboard 100 of FIG. 1 except for that the CPU 10B is mounted instead of the processor circuit 10 of FIG. 1 and the TPM 30 is newly mounted. According to the present embodiment, the motherboard 100B operates as the processor circuit. Hereinafter, the motherboard 100B is also referred to as a processor circuit 100B.

The CPU 10B is similar to the processor circuit 10 of FIG. 1 except for that the CPU 10B includes a version storage unit 12B instead of the version storage unit 12 of FIG. 1. Only the counter 12b (on-chip OTP memory) that generates the counter value CNTb is mounted over the version storage unit 12B. The version storage unit 12B is an example of the nonvolatile memory.

According to the present embodiment, the counter 12a is mounted in the TPM 30 that is a security chip including the security functions. Accordingly, at the start of the firmware 22 held in the firmware storage area 20, the version verification unit 14 reads the counter value CNTa held in the counter 12a in the TPM 30 with the counter value CNTb held in the counter 12b of the version storage unit 12B and compares the counter value CNTa and the counter value CNTb to each other. The firmware update operation performed by the CPU 10B of FIG. 7 is the same as that of FIGS. 2A to 2C and FIG. 3.

As illustrated in FIG. 7, for example, in a case where the TPM 30 has already been mounted in the motherboard 100B, the counter 12a may be realized by using the TPM 30. Thus, a resource for providing the counter 12a may be reduced. As described above, since the counter 12a (OTP) may be mounted at an arbitrary location accessible from the version verification unit 14, a barrier to incorporation of a method of verifying the version of the firmware 22 into the motherboard 100B may be reduced.

As described above, according to the present embodiment, effects similar to those of the above-described embodiment may be obtained. For example, the version may be incremented or decremented a plurality of times with the two counters CNTa and CNTb, and accordingly, the space of the memory for managing the version of software such as firmware may be suppressed. Upgrading and downgrading of the version may be easily managed by using the check value that is the difference between the counter values CNTa and CNTb of the counters 12a and 12b.

According to the present embodiment, in the case where the TPM 30 has already been mounted over the motherboard 1006, the counter 12a may be realized by using the TPM 30. Thus, the resource for providing the counter 12a may be reduced. Since the counter 12a (OTP) may be mounted at an arbitrary location accessible from the version verification unit 14, the barrier to the incorporation of the method of verifying the version of the firmware 22 into the motherboard 100B may be reduced.

Features and advantages of the embodiments are clarified from the detailed description above. The scope of claims is intended to cover the features and advantages of the embodiments as described above within a scope not departing from the spirit and scope of right of the claims. Any person having ordinary skill in the art may easily conceive every improvement and alteration. Accordingly, the scope of inventive embodiments is not intended to be limited to that described above and may rely on appropriate modifications and equivalents included in the scope disclosed in the embodiments.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A processor circuit for managing a version of software to be started comprising:
a nonvolatile memory that holds a first counter value of a first counter and a second counter value of a second counter, and
a start control circuit that updates the first counter value and maintains the second counter value in a case where the version of the software is incremented, that maintains the first counter value and updates the second counter value in a case where the version of the software is decremented, and starts the software in a case where the version of the software to be started is equal to a check value for a version check indicated by a difference between the first counter value and the second counter value.

2. The processor circuit according to claim 1, wherein
the nonvolatile memory that holds the first counter value and the second counter value and that has a plurality of bits allows writing of a value of each of the plurality of bits only once, wherein,
when the version of the software is incremented by one, the start control circuit writes a value to one of a plurality of bits of the first counter, and wherein
the check value is indicated by a difference between the number of bits to which values are written in the first counter and the number of bits to which the values are written in the second counter.

3. The processor circuit according to claim 1, wherein,
when the version of the software to be started is greater than the check value, the start control circuit updates the first counter value until the check value and the version of the software to be started become equal to each other.

4. The processor circuit according to claim 1, wherein,
when the version of the software to be started is smaller than the check value, the start control circuit stops start of the software.

5. The processor circuit according to claim 1, wherein
the start control circuit updates the second counter value of the second counter based on success in an authentication process.

6. The processor circuit according to claim 1, wherein
the nonvolatile memory includes a first nonvolatile memory that holds the first counter value and a second nonvolatile memory that holds the second counter value, wherein
the first nonvolatile memory that has a plurality of bits allows writing of a value of each of the plurality of bits only once, and wherein
the second nonvolatile memory that has a plurality of bits allows rewriting of a value of each of the plurality of bits a plurality of times.

7. The processor circuit according to claim 1, wherein
the first counter is mounted in a security chip that includes a security function.

8. A method of managing a version of software to be started performed by a processor circuit that comprises a nonvolatile memory that holds a first counter value of a first counter and a second counter value of a second counter, the method including:
updating the first counter value and maintaining the second counter value in a case where the version of the software is incremented;
maintaining the first counter value and updating the second counter value in a case where the version of the software is decremented; and
starting the software in a case where the version of the software to be started is equal to a check value for a version check indicated by a difference between the first counter value and the second counter value.

9. A non-transitory computer-readable recording medium storing a version management program for causing a processor circuit, that comprises a nonvolatile memory that holds a first counter value of a first counter and a second counter value of a second counter, to perform:
updating the first counter value and maintaining the second counter value in a case where the version of the software is incremented;
maintaining the first counter value and updating the second counter value in a case where the version of the software is decremented; and
starting the software in a case where the version of the software to be started is equal to a check value for a version check indicated by a difference between the first counter value and the second counter value.
